(19) United States
(12) Patent Application Publication
(10) Pub. No.: US 2016/0071137 A1
(43) Pub. Date: Mar. 10, 2016

(54) CROSS-BORDER TREND ALERTS AND VISUALIZATIONS

(71) Applicant: NEELAKANTAN SUNDARESAN, Mountain View, CA (US)

(72) Inventor: NEELAKANTAN SUNDARESAN, Mountain View, CA (US)

(21) Appl. No.: 14/844,771

(22) Filed: Sep. 3, 2015

Related U.S. Application Data
(60) Provisional application No. 62/046,847, filed on Sep. 5, 2014.

(51) Int. Cl. G06Q 30/02

(52) U.S. Cl. CPC G06Q 30/0205

(57) ABSTRACT

Systems and methods for cross-border trend alerts and visualizations are provided. In example embodiments, trade data corresponding to a plurality of transactions is accessed. Transaction attributes are extracted from the trade data. The plurality of transactions are filtered according to the extracted transaction attributes. A trend is inferred based on the extracted transaction attributes for the filtered plurality of transactions. A visualization representative of the filtered plurality of transactions is generated. The visualizations is displayed on a user interface of a user device.

### RELATED APPLICATIONS

This application claims the priority benefit, under 35 U.S.C. Section 119(e), to U.S. Provisional Application No. 62/046,847, entitled “CROSS-BORDER TRANSACTION ANALYSIS AND VISUALIZATIONS,” filed Sep. 5, 2014, which is hereby incorporated by reference in its entirety.

### TECHNICAL FIELD

Embodiments of the present disclosure relate generally to computer generated visualization technology and, more particularly, but not by way of limitation, to cross-border trend alerts and visualizations.

### BACKGROUND

Modern global commerce involves transactions between parties in many different countries and geographic regions on a massive scale. Online merchants often facilitate commerce between these countries and geographic regions and collect a vast body of trade data. Analyzing and providing useful indications of changes in the trade data to the right people at the right time can be a challenge given the dynamic nature and enormous size of the data set.

### BRIEF DESCRIPTION OF THE DRAWINGS

Various ones of the appended drawings merely illustrate example embodiments of the present disclosure and should not be considered as limiting its scope.

FIG. 1 is a block diagram illustrating a networked system, according to some example embodiments.

FIG. 2 is a block diagram showing example components provided within the cross-border analytics system of FIG. 1, according to some example embodiments.

FIG. 3 is a diagram illustrating example cross-border transactions associated with various countries and geographic regions, according to some example embodiments.

FIG. 4 is a flow diagram illustrating an example method for generating a visualization based on trade data associated with cross-border transactions, according to some example embodiments.

FIG. 5 is a flow diagram illustrating further example operations for generating a visualization based on trade data associated with cross-border transactions, according to some example embodiments.

FIG. 6 is a flow diagram illustrating example operations for generating trend alerts based on trade data associated with cross-border transactions, according to some example embodiments.

FIG. 7 is a flow diagram illustrating example operations for automatically performing a task in response to inferring a trend, according to some example embodiments.

FIG. 8 is a flow diagram illustrating an example method for identifying a user and providing the identified user with a link to a visualization configuration, according to some example embodiments.

FIG. 9 is a flow diagram illustrating an example method for identifying a visualization based on user data of the user, according to some example embodiments.

FIG. 10 is user interface diagrams depicting an example alert associated with inferring a trend from the trade data, according to some example embodiments.

FIG. 11 is user interface diagrams depicting an example user interface that includes a generated visualization of the trade data associated with a particular country or geographic region, according to some example embodiments.

FIG. 12 is user interface diagrams depicting an example user interface that includes a generated visualization of the trade data associated with multiple countries or geographic regions, according to some example embodiments.

FIG. 13 is a block diagram illustrating an example of a software architecture that may be installed on a machine, according to some example embodiments.

FIG. 14 illustrates a diagrammatic representation of the machine in the form of a computer system within which a set of instructions may be executed for causing the machine to perform any one or more of the methodologies discussed herein, according to an example embodiment.

### DETAILED DESCRIPTION

The description that follows includes systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

Online companies (e.g., PAYPAL®) often sit in the middle between parties performing transactions between different countries and geographic regions. Such online companies collect a trade data set that includes a vast amount of data associated with such transactions. This trade data is dynamic and constantly changing. Analyzing the trade data in terms of countries and geographic regions can provide useful insights since cross-border trade (herein, also referred to as “cross-border transactions”) can be sensitive and influenced by a wide variety of factors and catalysts (e.g., supply shortages in a particular region, geopolitical unrest in a particular country, localized and instant popularity of a product in a particular region, regional weather phenomenon, or changes in regional regulations). Analyzing the trade data to determine a trend can be valuable to users of such online companies (e.g., buyers and sellers of an e-commerce website). However, analyzing such a large data set that is constantly changing and providing information to interested parties at the right time can be challenging. Described herein are techniques to automatically analyze and identify trends, provide analysis tools for users to analyze such data, and automatically responding to identified trends.

In various example embodiments, a server system accesses trade data for a plurality of transactions and extracts transaction attributes from the trade data. In various example embodiments, the server system then filters the plurality of transactions according to the transaction attributes, infer trends from the trade data, generate various visualizations to assist a user in analyzing the trade data (e.g., a chord diagram show transactions between various countries or geographic regions), provide notifications of the inferred trends, and automatically perform tasks in response to detecting trends. These tools and techniques provide users with insights at the right time to allow users to make decisions regarding trade activity.

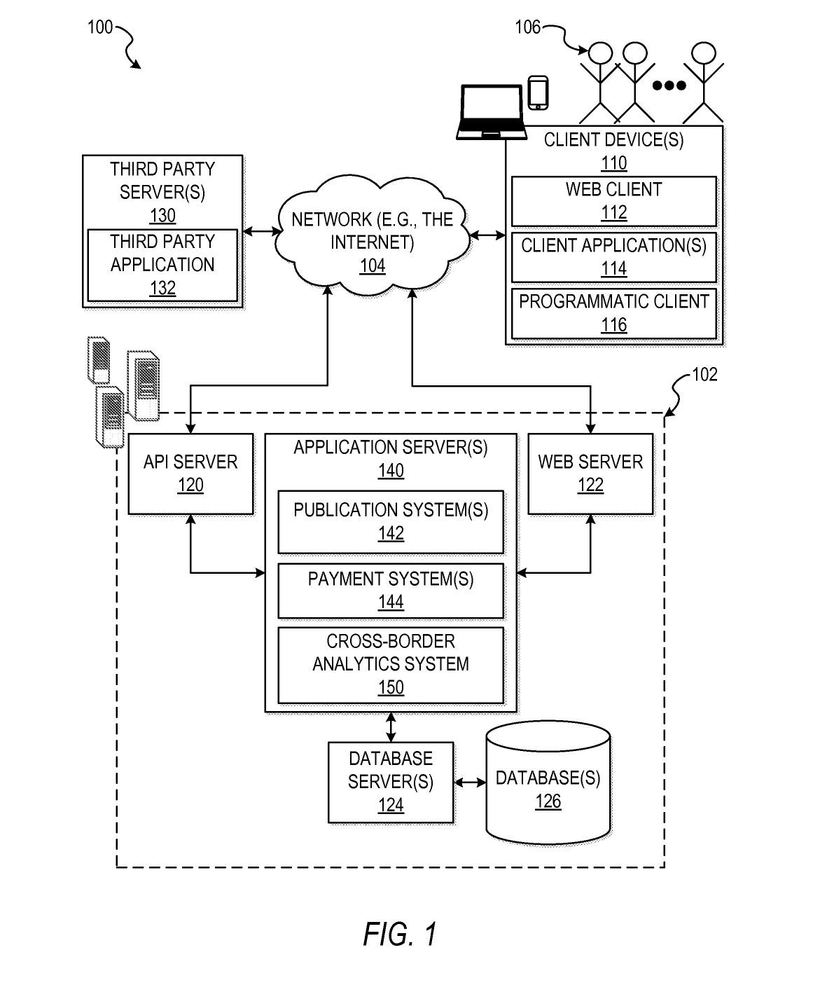

With reference to FIG. 1, an example embodiment of a high-level client-server-based network architecture 100 is shown. A networked system 102, in the example forms of a network-based publication or payment system, provides server-side functionality via a network 104 (e.g., the Internet or wide area network (WAN)) to one or more client devices 110. In some implementations, a user (e.g., user 106) interacts with the networked system 102 using the client device 110. FIG. 1 illustrates, for example, a web client 112 (e.g., a browser, such as the INTERNET EXPLORER® browser developed by MICROSOFT® Corporation of Redmond, Wash. State), client applications 114, and a programmatic client 116 executing on the client device 110. The client device 110 includes the web client 112, the client application(s) 114, and the programmatic client 116 alone, together, or in any suitable combination. Although FIG. 1 shows one client device 110, in other implementations, the network architecture 100 comprises multiple client devices.

In various implementations, the client device 110 comprises a computing device that includes at least a display and communication capabilities that provide access to the networked system 102 via the network 104. The client device 110 comprises, but is not limited to, a remote device, work station, computer, general purpose computer, Internet appliance, hand-held device, wireless device, portable device, wearable computer, cellular or mobile phone, Personal Digital Assistant (PDA), smart phone, tablet, ultrabook, netbook, laptop, desktop, multi-processor system, microprocessor-based or programmable consumer electronic, game consoles, set-top box, network Personal Computer (PC), mini-computer, and so forth. In an example embodiment, the client device 110 comprises one or more of a touch screen, accelerometer, gyroscope, biometric sensor, camera, microphone, Global Positioning System (GPS) device, and the like.

The client device 110 communicates with the network 104 via a wired or wireless connection. For example, one or more portions of the network 104 comprises an ad hoc network, an intranet, an extranet, a Virtual Private Network (VPN), a Local Area Network (LAN), a wireless LAN (WLAN), a Wide Area Network (WAN), a wireless WAN (WWAN), a Metropolitan Area Network (MAN), a portion of the Internet, a portion of the Public Switched Telephone Network (PSTN), a cellular telephone network, a wireless network, a Wireless Fidelity (WI-FI®) network, a Worldwide Interoperability for Microwave Access (WiMax) network, another type of network, or any suitable combination thereof.

In some example embodiments, the client device 110 includes one or more of the applications (also referred to as “apps”) such as, but not limited to, web browsers, book reader apps (operable to read e-books), media apps (operable to present various media forms including audio and video), fitness apps, biometric monitoring apps, messaging apps, electronic mail (email) apps, and e-commerce site apps (also referred to as “marketplace apps”). In some implementations, the client application(s) 114 include various components operable to present information to the user and communicate with networked system 102. In some embodiments, if the e-commerce site application is included in the client device 110, then this application is configured to locally provide the user interface and at least some of the functionalities with the application configured to communicate with the networked system 102, on an as needed basis, for data or processing capabilities not locally available (e.g., access to a database of items available for sale, to authenticate a user, to verify a method of payment). Conversely, if the e-commerce site application is not included in the client device 110, the client device 110 can use its web browser to access the e-commerce site (or a variant thereof) hosted on the networked system 102.

The web client 112 accesses the various systems of the networked system 102 via the web interface supported by a web server 122. Similarly, the programmatic client 116 and client application(s) 114 accesses the various services and functions provided by the networked system 102 via the programmatic interface provided by an Application Program Interface (API) server 120. The programmatic client 116 can, for example, be a seller application (e.g., the Turbo Lister application developed by EBAY® Inc., of San Jose, Calif.) to enable sellers to author and manage listings on the networked system 102 in an off-line manner, and to perform batch-mode communications between the programmatic client 116 and the networked system 102.

Users (e.g., the user 106) comprise a person, a machine, or other means of interacting with the client device 110. In some example embodiments, the user is not part of the network architecture 100, but interacts with the network architecture 100 via the client device 110 or another means. For instance, the user provides input (e.g., touch screen input or alphanumeric input) to the client device 110 and the input is communicated to the networked system 102 via the network 104. In this instance, the networked system 102, in response to receiving the input from the user, communicates information to the client device 110 via the network 104 to be presented to the user. In this way, the user can interact with the networked system 102 using the client device 110.

The API server 120 and the web server 122 are coupled to, and provide programmatic and web interfaces respectively to, one or more application server(s) 140. The application server(s) 140 can host one or more publication system(s) 142, payment system(s) 144, and a cross-border analytics system 150, each of which comprises one or more modules or applications and each of which can be embodied as hardware, software, firmware, or any combination thereof. The application server(s) 140 are, in turn, shown to be coupled to one or more database server(s) 124 that facilitate access to one or more information storage repositories or database(s) 126. In an example embodiment, the database(s) 126 are storage devices that store information to be posted (e.g., publications or listings) to the publication system(s) 142. The database(s) 126 also stores digital good information in accordance with some example embodiments.

Additionally, a third party application 132, executing on third party server(s) 130, is shown as having programmatic access to the networked system 102 via the programmatic interface provided by the API server 120. For example, the third party application 132, utilizing information retrieved from the networked system 102, supports one or more features or functions on a website hosted by the third party. The third party website, for example, provides one or more promotional, marketplace, or payment functions that are supported by the relevant applications of the networked system 102.

The publication system(s) 142 provides a number of publication functions and services to the users that access the networked system 102. The payment system(s) 144 likewise provides a number of functions to perform or facilitate payments and transactions. While the publication system(s) 142 and payment system(s) 144 are shown in FIG. 1 to both form part of the networked system 102, it will be appreciated that, in alternative embodiments, each system 142 and 144 may form part of a payment service that is separate and distinct from the networked system 102. In some example embodiments, the payment system(s) 144 may form part of the publication system(s) 142.

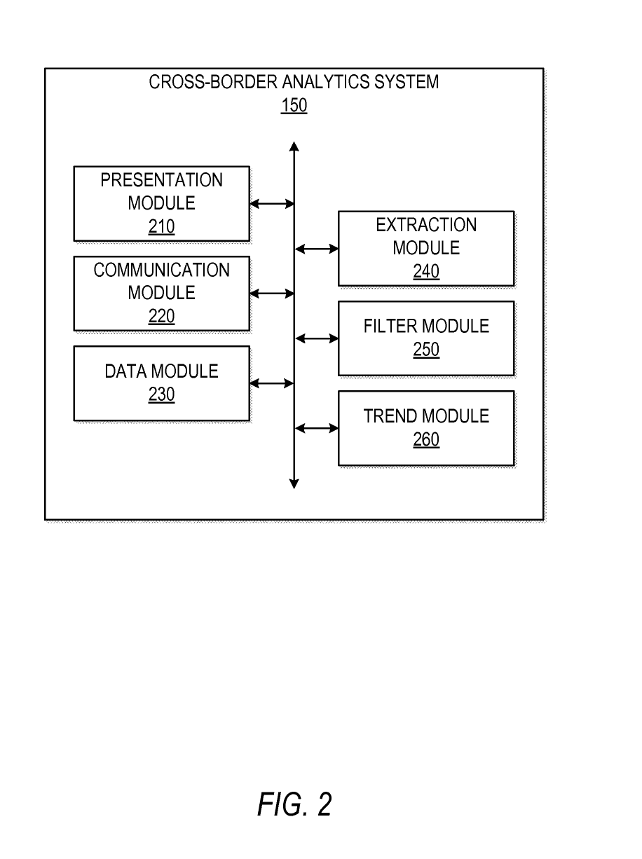

In some implementations, the cross-border analytics system 150 provides functionality to analyze and infer trends in trade data and generate visualizations and notifications associated with the inferred trends. In some example embodiments, the cross-border analytics system 150 communicates with the client device 110, the third party server(s) 130, the publication system(s) 142 (e.g., retrieving listings), and the payment system(s) 144 (e.g., purchasing an item in a listing). In an alternative example embodiment, the cross-border analytics system 150 is a part of the publication system(s) 142. The cross-border analytics system 150 will be discussed further in connection with FIG. 2 below.

Further, while the client-server-based network architecture 100 shown in FIG. 1 employs a client-server architecture, the present inventive subject matter is, of course, not limited to such an architecture, and can equally well find application in a distributed, or peer-to-peer, architecture system, for example. The various systems of the applications server(s) 140 (e.g., the publication system(s) 142 and the payment system(s) 144) can also be implemented as standalone software programs, which do not necessarily have networking capabilities.

FIG. 2 is a block diagram of the cross-border analytics system 150 that provides functionality to analyze trade data to infer trends and generate notifications and visualizations associated with the inferred trends. In an example embodiment, the cross-border analytics system 150 includes a presentation module 210, a communication module 220, a data module 230, an extraction module 240, a filter module 250, and a trend module 260. All, or some, of the modules 210-260 of FIG. 2, communicate with each other, for example, via a network coupling, shared memory, and the like. It will be appreciated that each module can be implemented as a single module, combined into other modules, or further subdivided into multiple modules. Other modules not pertinent to example embodiments can also be included, but are not shown.

The presentation module 210 provides various presentation and user interface functionality operable to interactively present and receive information from the user. For instance, the presentation module 210 may generate a visualization based on the transaction attributes (e.g., a chord diagram showing transactions corresponding to various countries throughout the world, graphs, charts). In another instance, the presentation module 210 can cause presentation of various alerts, notifications, or other user interfaces that provide the user with information associated with analyzes associated with the trade data. In various example embodiments, the presentation module 210 presents or causes presentation or display of information (e.g., visually displaying information on a screen, acoustic output, haptic feedback). Interactively presenting information is intended to include the exchange of information between a particular device and the user. The user may provide input to interact with the user interface in many possible manners such as alphanumeric, point based (e.g., cursor), tactile, or other input (e.g., touch screen, tactile sensor, light sensor, infrared sensor, biometric sensor, microphone, gyroscope, accelerometer, or other sensors), and the like. It will be appreciated that the presentation module 210 provides many other user interfaces to facilitate functionality described herein. Further, it will be appreciated that “presenting” as used herein is intended to include communicating information or instructions to a particular device that is operable to perform presentation based on the communicated information or instructions.

The communication module 220 provides various communications functionality and web services. For example, the communication module 220 provides network communication such as communicating with the networked system 102, the client device 110, and the third party server(s) 130. In various example embodiments, the network communication may operate over wired or wireless modalities. Web services are intended to include retrieving information from the third party server(s) 130, the database(s) 126, and the application server(s) 140. In some implementations, information retrieved by the communication module 220 comprises data associated with the user (e.g., user profile information from an online account, social network service data associated with the user), data associated with one or more items listed on an e-commerce website (e.g., images of the item, reviews of the item, item price), or other data to facilitate the functionality described herein.

The data module 230 may access the trade data or the transaction data from various sources such as the publication system(s) 142, the payment system(s) 144, and in some instances, the third party server(s) 130. The data module 230 may access the trade data using various schemes and techniques. For instance, the data module 230 may access a portion of the trade data associated with a particular attribute. In a specific instance, the data module 230 may lookup transactions associated with a particular category of good, country, and so on. In some implementations, the data module 230 may store various data, for example, in database(s) 126. For instance, the data module 230 may store results from various analyses, user preferences, and so forth. In further example embodiments, the data module 230 may maintain a database of trade data indexed or structured to allow for searching to identifying various trends. For example, the data module 230 may store the trade data to allow for a query of transactions associated with a particular item category, for a particular country, over a specified period of time, among other query filters.

The extraction module 240 provides functionality to extract transaction attributes from the trade data. That is to say, the extraction module 240 identifies, from the trade data, the transaction attributes for each respective transaction of the plurality of transactions. For example, the extraction module 240 extracts, infers, derives, or otherwise identifies a particular transaction attribute of a particular transaction such as a transaction origin geolocation and a transaction destination geolocation from the trade data. The extraction module 240 may then infer that the particular transaction is a cross-border transaction. The transaction attributes include, for example, countries associated with the transaction (e.g., origin country, destination country), shipping method, feedback associated with the transaction, item category (e.g., business & industrial, collectibles, electronics, fashion, home & garden, lifestyle, media), transaction value, item characteristics associated with the transaction (e.g., item was defective, item is a brand name or generic), transaction party characteristics (e.g., buyer is a frequent high spender, casual buyer, power seller), among many other transaction attributes.

The filter module 250 provides functionality to filter data set such as filtering the plurality of transactions associated with the trade data based on the extracted transaction attributes. For example, the filter module 250 filters out transaction of the plurality of transactions that are not cross-border transactions. In further example embodiments, the filter module 250 filters the plurality of transactions according to a user-specified transaction attribute.

The trend module 260 provides functionality to infer, detect, derive, or otherwise identify trends based on an analysis of the trade data. For example, the trend module 260 infers a trend based on the extracted transaction attributes of the filtered plurality of transactions. In this example, the trend may be indicative of future cross-border transactions. For instance, the trend module 260 identifies an abnormality, anomaly, or other statistically significant features or characteristics associated with the trade data. In a specific example, the trend module 260 identifies a change in imports or exports corresponding to a particular country that is significant as compared to historical changes in imports or exports for that particular country.

In further example embodiments, the trend module 260 performs various functions to prepare or condition the trade data for analysis. For instance, the trend module 260 standardizes various pieces of the trade data to facilitate analysis of the trade data (e.g., determine a normal form for the data to allow for comparison and other mathematical analysis). In a specific example, a particular piece of the trade data may be referring to a particular item name (e.g., “digital camera,” “Digital SLR camera,” or “DSLR Camera”). Standardizing the item name results in a standardized form (e.g., “Digital SRL Camera”) that represents multiple similar forms. Standardizing a piece of information may provide for direct comparisons between standardized forms of information and for more accurate mathematical analysis to determine similarity between particular pieces of information. The trend module 260 may perform many other functions to prepare the trade data for analysis.

In still further example embodiments, the trend module 260 performs tasks on behalf of a particular user. For instance, the particular user may have specified a particular task to perform (e.g., automatically list an item for sale in a particular region) in response to detecting or inferring a trend from the trade data.

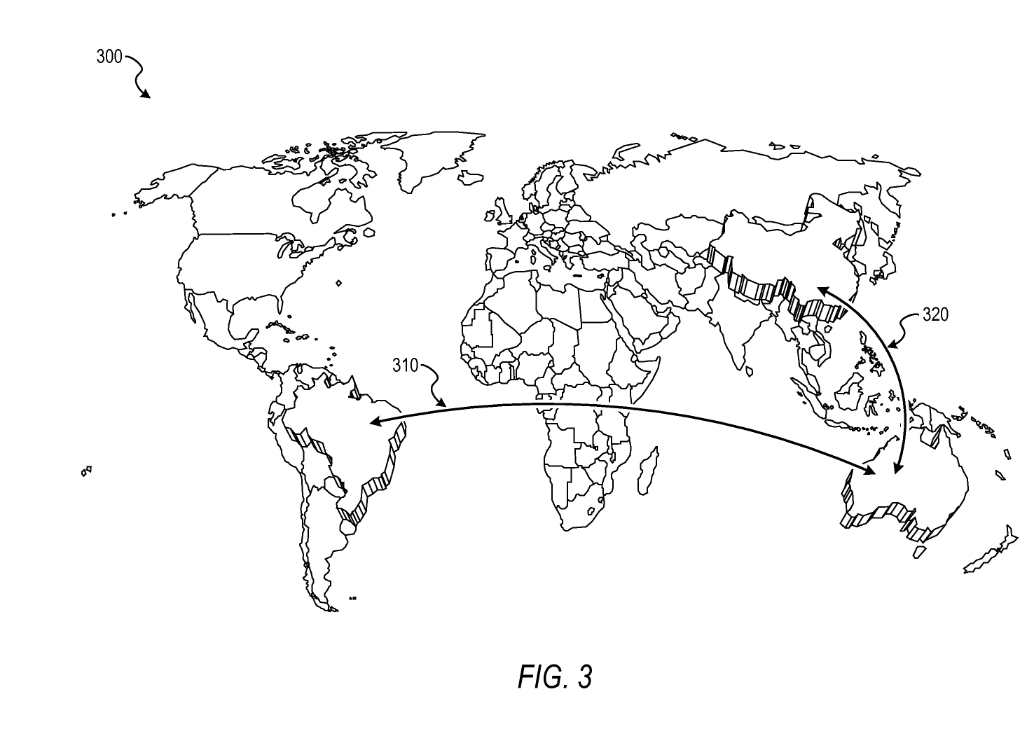

FIG. 3 is a diagram 300 illustrating example cross-border transactions associated with various countries, according to an example embodiment. In the diagram 300, line 310 and line 320 represent example cross-border transactions between various countries. The line 310 represents a cross-border transaction from Australia to Brazil and the line 320 represents a cross-border transaction from Australia to China. These example cross-border transactions may involve a particular user in, for example, Australia transacting via a website (e.g., PAYPAL®) with another party in another country. Cross-border transactions, such as those illustrated in the diagram 300, may be subject to various regulatory schemes corresponding to the countries associated with the particular cross-border transaction.

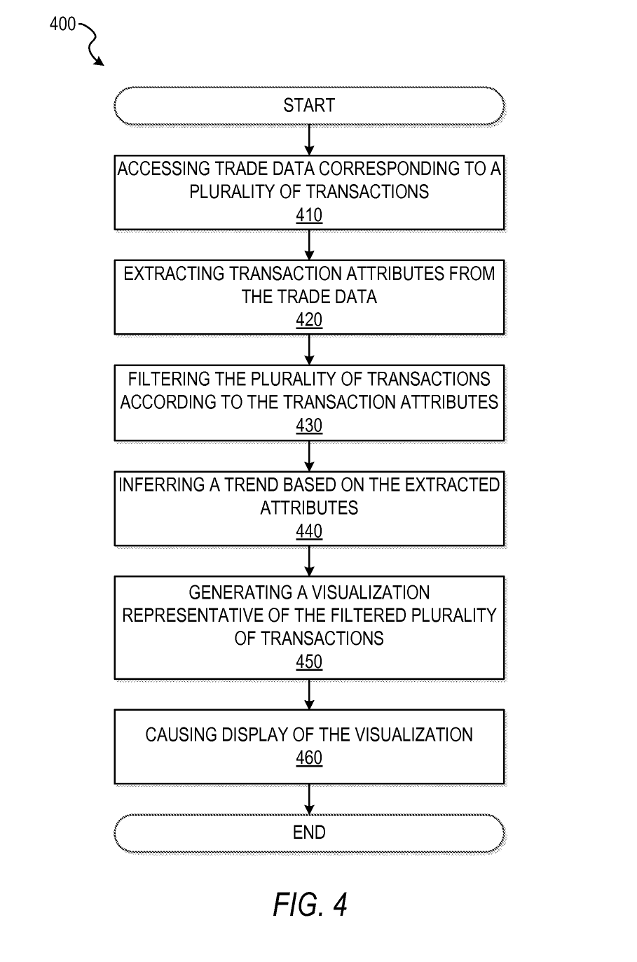

FIG. 4 is a flow diagram illustrating an example method 400 for generating a visualization based on trade data associated with cross-border transactions. The operations of the method 400 can be performed by components of the cross-border analytics system 150, and are so described below for the purposes of illustration.

At operation 410, the data module 230 accesses the trade data corresponding to the plurality of transactions. For example, the data module 230 may access the trade data from the publication system(s) 142, the payment system(s) 144 (e.g., e-commerce transaction histories), or elsewhere. The trade data includes data for respective transactions of the plurality of transaction such as transaction parties, transaction party geolocation, shipping origin, shipping destination, price, tax, regulatory compliance data, item description, payment method, payment currency, item category, item brand name, ratings and reviews of an item, and so on.

In various embodiments, the trade data includes data for historical transactions and data for real-time transactions. For example, transactions that are occurring in real time or near real time can be analyzed by the cross-border analytics system 150 to provide users with information and alerts that are current. Analysis of the historical transaction data can be useful to identify trends or changes happening in the real-time transaction data.

At operation 420, the extraction module 240 extracts transaction attributes from the trade data. In an example embodiment, the transaction attributes include a cross-border relationship attribute indicating that a particular transaction is associated with a border transgression (e.g., a particular transaction involving two or more countries) or a first region and a second region different than the first region. A particular transaction associated with a border transgression includes, for example a transaction with an origin (e.g., shipping origin or entity location) in a first country and a destination (e.g., shipping destination) in a second country. Region, as used herein, is intended to include a geographic area that is not necessarily a country but can also include a portion of a particular country or multiple countries together. A particular transaction being associated with a particular region includes, for example, a party to the transaction being a citizen of a country corresponding the particular region, a shipping origin or shipping destination from the particular region, and so forth. For example, the extraction module 240 identifies a cross-border relationship attribute for a particular transaction that originated in the United States with a buyer in the United Kingdom. That is to say, in an example, a particular transaction is associated with a particular cross-border relationship if the transaction involves more than one country (e.g., seller in Australia selling to a buyer in China).

In further example embodiments, the transaction attributes include, for example, countries associated with the transaction (e.g., origin country, destination country), shipping method, feedback associated with the transaction, item category (e.g., business & industrial, collectibles, electronics, fashion, home & garden, lifestyle, media), transaction value, item characteristics associated with the transaction (e.g., item was defective, item is a brand name or generic), transaction party characteristics (e.g., buyer is a frequent high spender, casual buyer, power seller), among many other transaction attributes. In a specific instance, the transaction attributes include basic parameters associated with a transaction, such as buyer, a country corresponding to the buyer (e.g., buyer's country of residence), seller, a country corresponding to the seller (e.g., seller's country of residence), shipping method, shipping origin, shipping destination, item, item description, value of transaction, and so forth. It will be appreciated that the terms “buyer” and “seller” as used herein are intended to include people, organization, companies, or other entities.

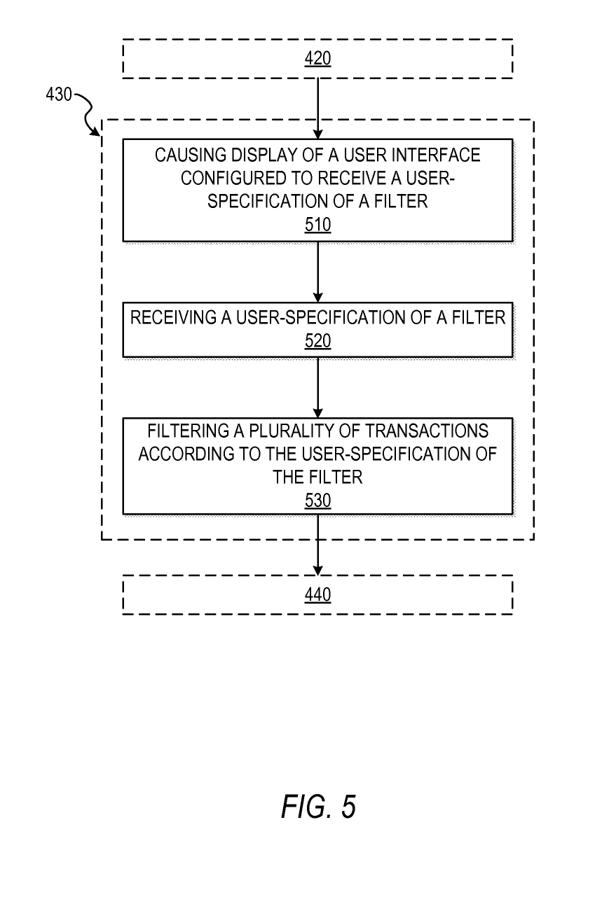

At operation 430, the filter module 250 filters the plurality of transactions according to a particular transaction attribute such as the cross-border relationship attribute that indicates that a particular transaction is associated with a first region and a second region different from the first region. In other embodiments, the filter module 250 filters the plurality of transactions based on other transaction attributes, a time period (e.g., within the last thirty day), or another metric. As will be discussed further in connection with FIG. 5 below, a user may provide input to a user interface configured to receive filter options such as filtering the trade data according to a particular item category.

At operation 440, the trend module 260 infers, detects, or otherwise identifies one or more trends based on the extracted transaction attributes of the filtered plurality of transactions. The trend can be indicative of future cross-border transaction associated with the first region and the second region. In some example embodiments, the trend is associated with the cross-border relationships and the transaction attributes. For example, a particular trend may be a statistically significant change in the trade data as compared to historical trade data. In a specific example, a particular trend may be exports from a country, such as Germany, changing a statistically significant amount (e.g., the change in exports for a particular period of time may be several standard deviations away from an average of exports over another period of time).

In further example embodiments, the data module 230 accesses regulation data (e.g., customs, import export laws) or other commerce related data (e.g., weather phenomena that may affect trade in a particular region or geo-political news and updates that may affect trade in particular region) associated with particular countries, and the trend module 260 analyzes the regulation data to determine an effect on particular item categories, trade between particular countries, and so on. In an example implementation, the data module 230 accesses the regulation data from the third party server(s) 130. For instance, the sale of various items, such as alcohol, may be prohibited by law in various countries. A change in prohibited items may have a dramatic effect on trade associated with the prohibited items. In some implementations, the trend module 260 detects such changes and the presentation module 210 causes presentation of a notification that includes such information to the user.

At operation 450, the presentation module 210 generates a visualization representative of the filtered plurality of transactions using the extracted transaction attributes for the filtered plurality of transactions and the inferred trend. In a specific example, the visualization comprises a chord diagram showing a portion of the trade data or a portion of the plurality of transactions associated with an origin country (e.g., a country associated with a seller) and a destination country (e.g., country associate with a buyer). The chord diagram may show bi-directional trade between a first country and a second country or various countries, regions, or sets of areas and illustrate the cross-border relationships to the user. In some embodiments, the chord diagram comprises chord lines that represents transactions between countries (e.g., a line from one country on the diagram to another country on the diagram representing transaction or trade activity). The trend module 260 may generate various transaction metrics summarizing trading activity between two particular countries. The presentation module 210 causes presentation or display of the transaction metrics generated by the trend module 260. For instance, the transaction metrics may include all, or some, transactions that occurred between two particular countries for a specified time period, a total value of the transactions that occurred between two particular countries for a specified time period, an average transaction value between two particular countries for a specified time period, and so on.

At operation 460, the presentation module 210 causes display of the generated visualization on a user interface of a user device of a user. In various embodiments, the user may interact with the visualization to alter or modify the visualization in real time. For instance, the user may interactively specify a particular country and more detailed information corresponding to the user-specified country is generated and presented to the user. In some embodiments, the visualization is generated, based in part, on a temporal component of the trade data. For instance, a timeline that indicates transaction occurrences over time may be generated and presented to the user. The visualization may incorporate a variety of visual elements, such as color, graphs, text, and so on, to assist the user in interpreting the data represented by the visualization.

In further example embodiments, the user navigates or otherwise explores the trade data via interacting with the visualization. In an example embodiment, the user selects various options, settings, and preferences to refine the appearance and content of the visualization. The data module 230 can store a particular user configuration of settings that the cross-border analytics system 150 accesses at a subsequent user session at a different time.

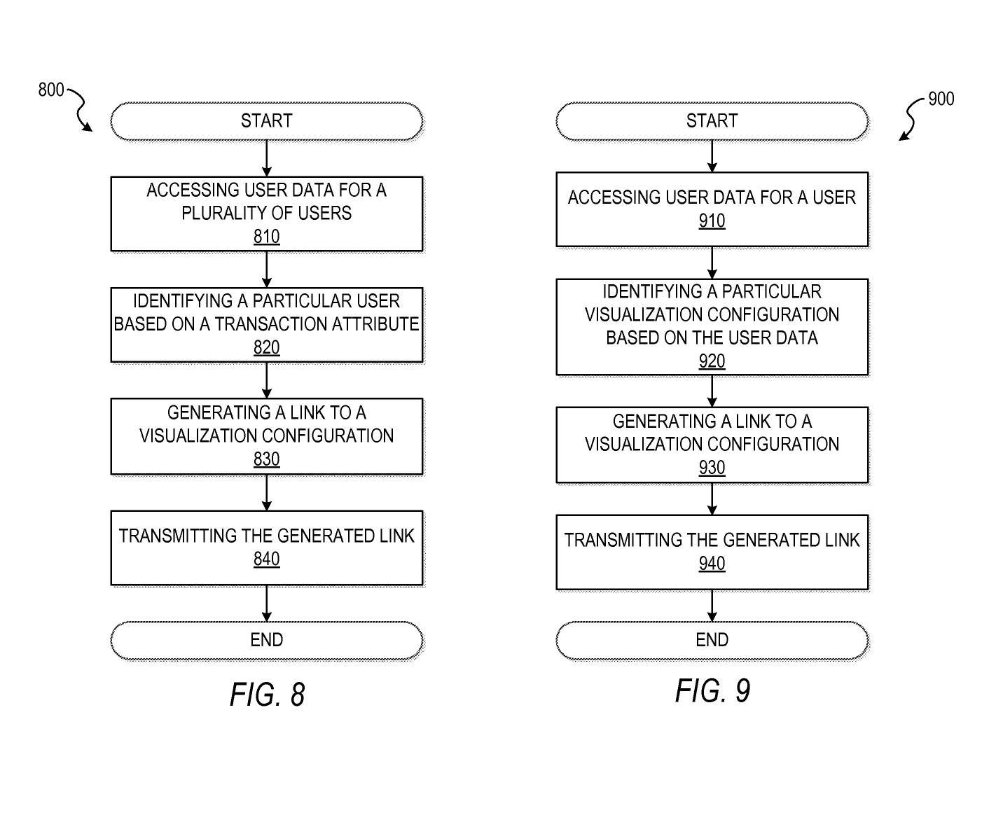

In still further embodiments, the presentation module 210 provides the user with an option to generate a link corresponding to particular settings or a particular configuration associated with the trade data as will be discussed in more detail below in connection with FIGS. 8 and 9 (e.g., a link to a particular a particular user configuration of settings accessible by other users). For instance, if the user applies various item category filters, country filters, and temporal filters (e.g., trade data for electronics exported by the United Kingdom over the past six month), the presentation module 210 provides an option to generate a link that provides access to the trade data with the settings specified by the user. The presentation module 210 may further provide an option to share the link with other user or other entities. In this way, the user may save and share particular states of the visualization based the trade data.

FIG. 5 is a flow diagram illustrating further example operations for generating a visualization based on trade data associated with cross-border transactions. At operation 420, the extraction module 240 extracts the transaction attributes from the trade data. Subsequently, at operation 430, the filter module 250 filters the plurality of transactions according to a particular transaction attribute. In some embodiments, operation 430 includes the operations of FIG. 5.

At operation 510, the presentation module 210 causes display of a user interface configured to receive a user-specification of a filter from the user device of the user. The user-specification of the filter includes instructions for filtering the plurality of transactions according to a user-specified transaction attribute. For example, the presentation module 210 generates and causes display of a user interface that includes the extracted transaction attributes as filter options. The user selects a particular transaction attribute among the options displayed. For instance, the user-specification of the filter specifies display of transactions of a particular item category (e.g., home & garden items or items greater than or less than a user-specified value) and a particular origin (e.g., seller country) country and destination country (e.g., buyer country).

At operation 520, the communication module 220 receives a user-specification of a filter from the user device of the user. For example, the user-specification of the filter comprises user-specified transaction attributes to filter out (e.g., remove transaction data associated with the user-specified transaction attributes).

At operation 530, the filter module 250 filters the plurality of transactions according to the user-specification of the filter. In this way, the user manipulates, adjusts, or modifies the output of the visualization generated by the presentation module 210 and alerts that are generated by the trend module 260.

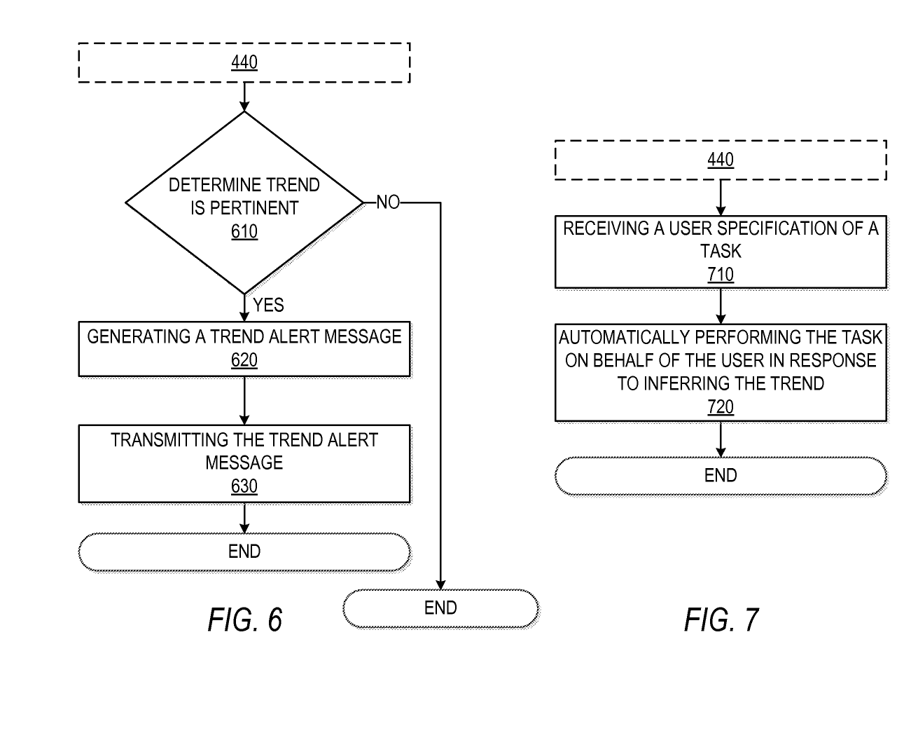

FIG. 6 is a flow diagram illustrating example operations for generating trend alerts based on trade data associated with cross-border transactions. At operation 440, the trend module 260 infers the trend based on the extracted transaction attributes. Subsequently, the operations of FIG. 6 are performed according to some embodiments.

At operation 610, the trend module 260 determines whether the inferred trend is pertinent. For instance, the trend module 260 determines a significance score for the trend, and if the trend module 260 determines that the significance score exceeds a threshold hold, the threshold module 260 then determines satisfaction of the pertinence condition and proceeds to operation 620 (indicated by “YES” in FIG. 6). Otherwise, the method 400 may end or start over again (indicated by “NO” in FIG. 6). The trend module 260 determines the significance score, for example, if the trend is statistically significant (e.g., a change several standard deviations away from a mean), the trend is associated with breaking news (e.g., keyword comparison of breaking news feeds with keywords associated with the trend), is affecting trade in a significant way, or if a threshold number of other user have viewed or otherwise engaged with the trend (e.g., clicked on a link associated with the trend). In a specific example, a change in daily total value of trade that exceeds an average total value of trade for a period of time (e.g., 30 days or a user-specified period of time) by a statistically significant amount (e.g., three times a standard deviation for the 30 day period of time) indicates a high significance score and the trend module 260 determines satisfaction of the pertinence condition based on the high significance score.

In further example embodiments, the trend module 260 determines a relevance score as part of or in conjunction with the significance score in determining satisfaction of the pertinence condition. The trend module 260 determines the relevance score for a particular user using the user data of the particular user. For example, if the trend is associated with a particular region and the user data indicates that the user conducts transactions with the particular region, the trend module 260 may determine a high relevance score and also determine satisfaction of the pertinence condition. In other words, the trend module 260 extracts user attributes of a particular user and compares or matches the user attributes with the transaction attributes associated with the trend to determine a relevance score for the trend with respect to the particular user.

At operation 620, the trend module 260 generates a trend alert message or notification describing the trend in response to inferring the trend. For instance, the user may specify an interest (e.g., user preferences) in trends associated with one or more particular transaction attributes (e.g., a particular country, a particular item category) and when such a trend is detected, the user is notified of the trend. In some example embodiments, user data corresponding to the user may be accessed and analyzed to automatically determine trends the user may be interested in. For example, if the user's sales history or purchase history indicates purchases or sales to a particular region or country, trends associated with that region or country are provided to the user via a notification or alert. Such trend detection and notification can assist the user in optimizing trade for items they are buying or selling. In still other embodiments, the trend module 260 identifies similar users that are similar to the user (e.g., matching user demographic information or user transaction history) and provides trends to the user that the similar user viewed or indicated an interest in (e.g., the interest being based on engagement metrics such as the user clicking on a particular notification include a particular trend or spending more time viewing a particular).

At operation 630, the communication module 220 transmits the trend alert message to a user device of the user. For example, the communication module 220 communicates the message via email, text message, push notification, or another communication modality.

FIG. 7 is a flow diagram illustrating example operations for automatically performing a task in response to inferring a trend. At operation 440, the trend module 260 infers the trend based on the extracted transaction attributes. Subsequently, the operations of FIG. 7 are performed according to some embodiments.

At operation 710, the communication module 220 receives a user-specification of a task to be performed automatically in response to a trend. That is to say, the user provides a user-configured trend response task comprising a user-specified task trigger that when trigger automatically causes a particular task or action to be performed. For example, the user may specify that a portion of the user's inventory is to be automatically listed in response to detecting a trend indicating a certain increase in price for the inventory. In other embodiments, the user simply provides permission for the cross-border analytics system 150 to perform certain tasks on behalf of the user in response to detecting trends. The tasks include, for example, listing items for sale, increasing or decreasing a price for a listing, purchasing an item of an item listing, adding funds to a particular account, removing an item listing for sale, changing a currency of a particular transaction, and so forth. In alternative embodiments, the trend module 260 infers a task to be performed for the user rather than the task being user-specified (e.g., task other users have performed in response to the trend or a similar trend). In still other embodiments, the trend module 260 determines satisfaction of a pertinence condition prior to automatically performing a task, similar to operation 610 described above.

At operation 720, the trend module 260 automatically performs a task on behalf of the user in response to inferring the trend. In an example, the task comprises automatically listing for sale a portion of an inventory of the user associated with the trend. In a specific example, if the trend module 260 detects that the average selling price for a particular item category and country exceeds a threshold, the trend module 260 automatically lists for sale an item on behalf of the user. In this way, the cross-border analytics system 150 automatically assists the user in optimizing cross-border trade. In some embodiments, the trend module 260 provides the user with an option to perform a suggested task rather than automatically performing the task (e.g., a notification that includes an option to perform the task).

FIG. 8 is a flow diagram 800 illustrating an example method for identifying a user and providing the identified user with a link to a visualization configuration. The operations of the method 800 can be performed by components of the cross-border analytics system 150, and are so described below for the purposes of illustration.

At operation 810, the data module 230 accesses user data for a plurality of users. In various example embodiments, the user data indicates user transaction activity such as purchase history and sales history, user demographic data (e.g., citizenship, residency, gender, and age), and other user data.

At operation 820, the data module 230 or the trend module 260 identifies a particular user among the plurality of users based on the user data and a particular transaction attribute such as the cross-border transaction attribute. For example, the trend module 260 identifies a particular user associated with a particular region (e.g., performs transactions associated with the region or is a citizen or resident of the region) that matches a particular region of the cross-border transaction attribute.

At operation 830, the data module 230 generates a link to a visualization configuration of the visualization representation of the filtered plurality of transactions filtered according to the user-specification of the filter. In an example, when the user activates the link, the user device of the user is directed to a user interface generated by the cross-border analytics system 150 that presents the visualization using current data and the user-specification of the filter.

At operation 840, the communication module 220 transmits the generated link to the user device of the identified particular user. In this way, the cross-border analytics system 150 actively identifies users that may be interested in a particular visualization and provides those users with an option to view the particular visualization.

FIG. 9 is a flow diagram 900 illustrating an example method for identifying a visualization based on user data of the user. The operations of the method 900 can be performed by components of the cross-border analytics system 150, and are so described below for the purposes of illustration.

At operation 910, the data module 230 accesses user data for a plurality of users, similar to that described above in connection with operation 810. At operation 920, the data module 230 or the trend module 260 identifies a particular visualization configuration based on the user data of the user. This step differs from operation 820 discussed above in that the user may currently be using the cross-border analytics system 150 and wish to seek out visualizations personalized to their interests. Like operation 820 discussed above, the trend module 260 compares the aspects of the user data with aspects of particular visualizations to identify a particular visualizations the user may be interest in (e.g., matching geographic regions between the user data and the visualization configuration).

At operation 930, the data module 230 generates a link to the identified visualization configuration similar to that described above in connection with operation 830. At operation 940, the communication module 220 transmits the generated link to a user device of a user similar to that described above in connection with operation 840.

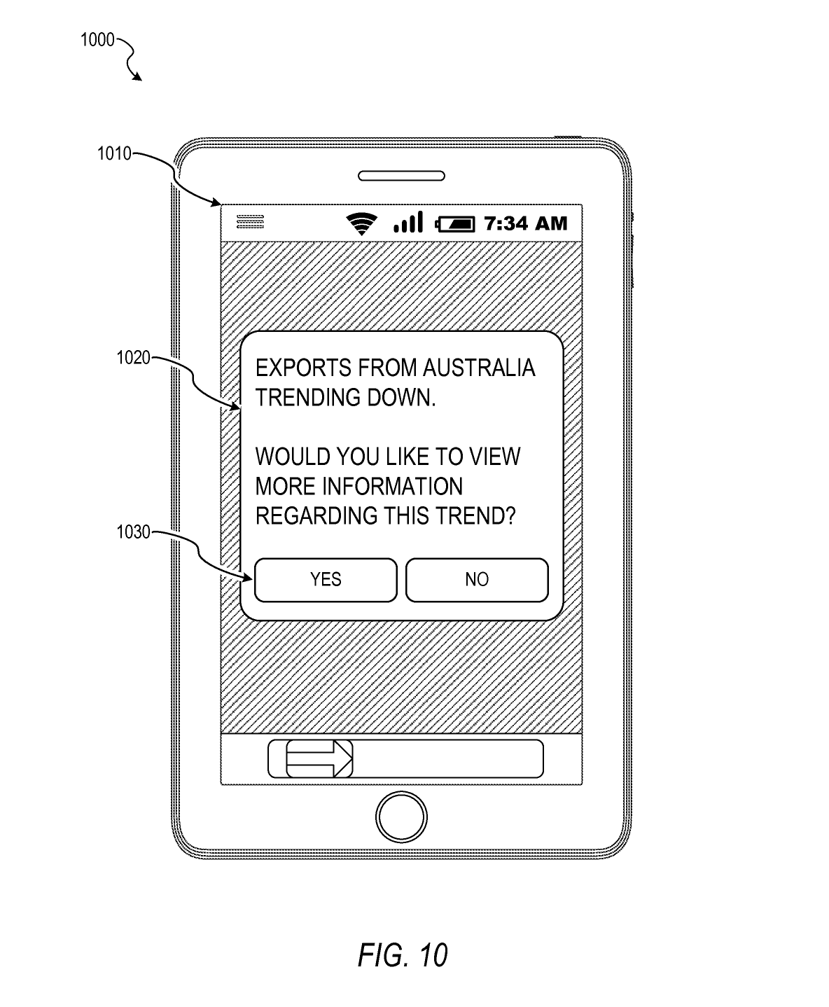

FIGS. 10-12 depict example user interfaces for interactively presenting information to the user. Although FIGS. 10-12 depict specific example user interfaces and user interface elements, these are merely non-limiting examples; many other alternate user interfaces and user interface elements can be generated by the presentation module 210 and caused to be presented to the user. It will be noted that alternate presentations of the displays of FIGS. 10-12 can include additional information, graphics, options, and so forth. Alternatively, other presentations can include less information, or provide abridged information for easy use by the user.

FIG. 10 depicts an example device 1000 displaying an example user interface 1010 that includes an alert or a notification 1020, according to some example embodiments. In various example embodiments, the presentation module 210 causes presentation of the notification 1020 to the user. For instance, the presentation module 210 communicates, to the device 1000, instructions to present the notification 1020. In some instances, the instructions include notification content, generated by the presentation module 210, such as a message (e.g., pertinent information) to be presented to the user. In example embodiments, the notification 1020 comprises a text message, such as Short Message Service (SMS) messages, Multimedia Messaging Service (MMS), Enhanced Messaging Service (EMS), and so forth. In other example embodiments, the notification 1020 comprises a push notification or another similar type of notification. In further example embodiments, the notification 1020 comprises interactive user interface elements such as user interface elements 1030. In these example embodiments, the user interface elements 1030 provide the user an option to make a selection (e.g., through an SMS system, mobile application).

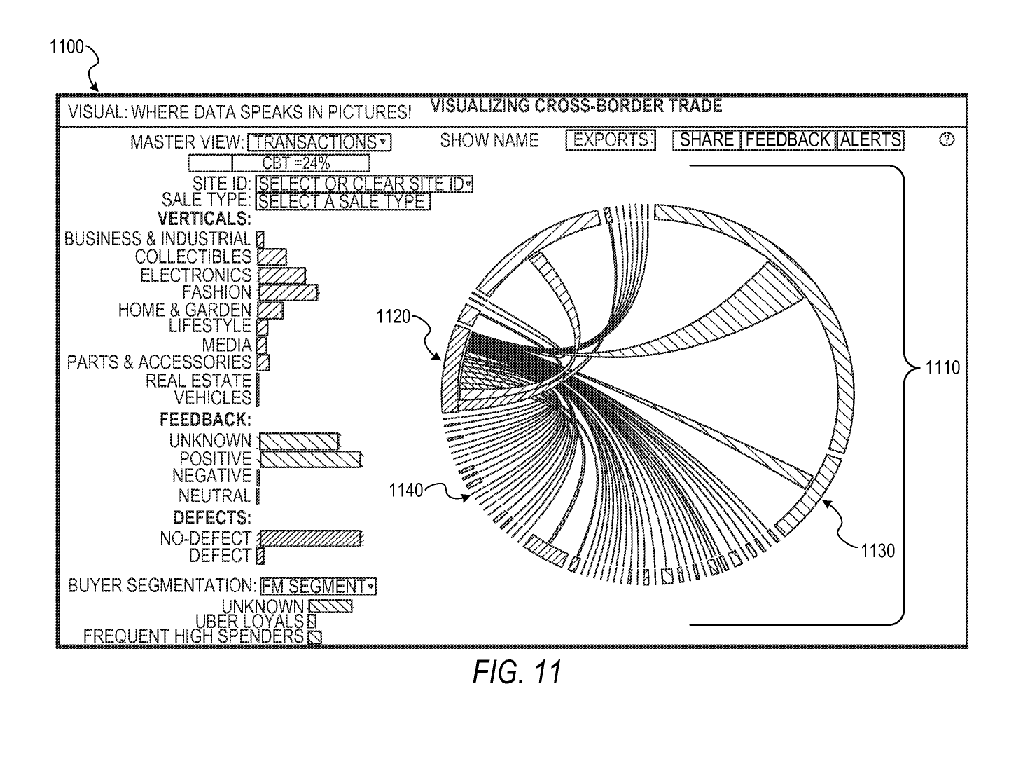

FIG. 11 is a user interface diagram depicting an example user interface 1100 that includes a generated visualization 1110 of the trade data associated with a particular country or geographic region. In an example embodiment, the generated visualization 1110 comprises a chord diagram representing cross-border trade between a particular country (e.g., the United Kingdom) and other countries or regions. In the chord diagram, each line may be representative of one or more transactions between two particular countries for a specified time period. A higher density of lines between two countries is indicative of a higher volume of trade between two countries. In an example embodiments, the user interacts with the chord diagram by hovering over a country to show import/export summary data within a specified time period.

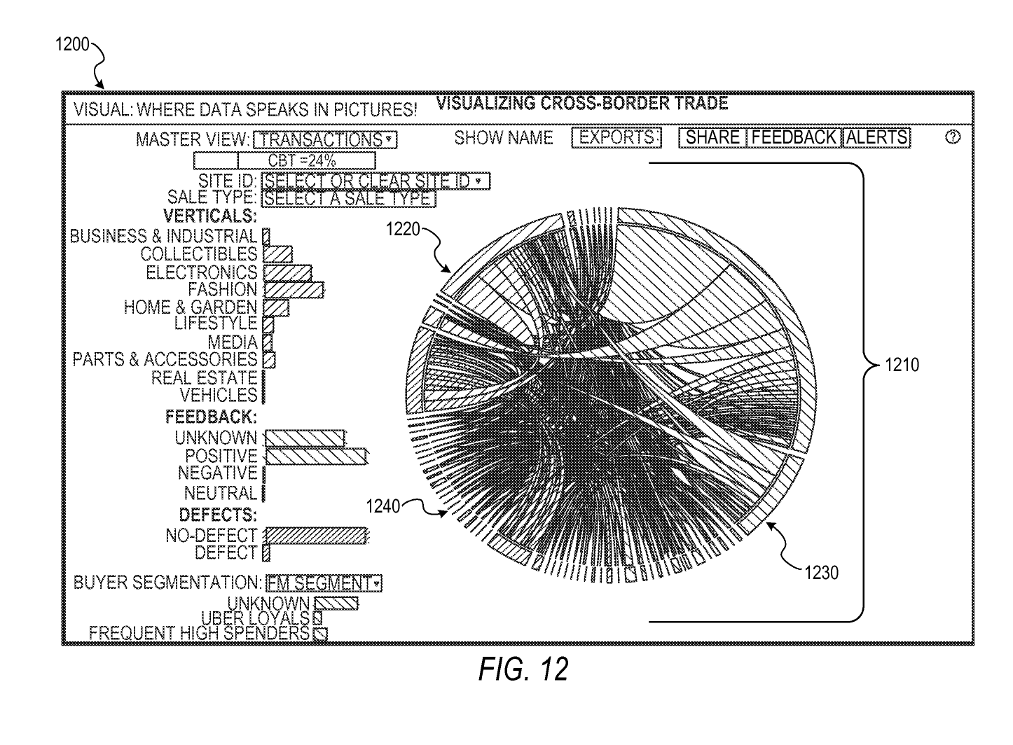

FIG. 12 is a user interface diagram depicting an example user interface 1200 that includes a generated visualization 1210 of the trade data associated with multiple countries or geographic regions. In an example embodiment, the generated visualization 1210 comprises a chord diagram representing cross-border trade between multiple countries.

In further example embodiments, the user interface 1200 includes options for the user to modify or alter the presentation of the trade data. In an example embodiment, options, preferences, and settings are overlaid or included on the chord diagram. For example, trade categories such as business & industrial, collectibles, electronics, fashion, home & garden, lifestyle, media, parts & accessories, real estate, and vehicles are show with an indication of a number of transactions associated with respective categories (e.g., a bar graph). In various implementations, the user may select a particular item category to filter the trade data to include items associate with the selected item category. For instance, if the user selects the fashion item category, the chord diagram may update in real time to show transactions associated with fashion item between various countries. In this way, the user interactively and dynamically filters the trade data.

In still further example embodiments, the user interface 1200 includes a timeline that indicates transactions over a time period. For instance, the user may specify one or more countries, one or more item categories and the presentation module 210 generates a timeline that indicates daily trade over the time period (e.g., indicated via a color coding). The user interface 1200 can include other graphs and analysis associated with the trade data. For example, the trend module 260 calculates the change in trade over time and the presentation module 210 generates a graphical representation (e.g., a line graph or other representation) of the calculated change in trade. The user interface 1200 can include alerts or notifications generated in response to the trend module 260 identifying a trend in the trade data. For instance, if the trend module 260 detects a significant change in exports from Australia, the presentation module 210 generates a notification indicating the significant change in Exports from Australia.

Certain embodiments are described herein as including logic or a number of components, modules, or mechanisms. Modules can constitute either software modules (e.g., code embodied on a machine-readable medium) or hardware modules. A “hardware module” is a tangible unit capable of performing certain operations and can be configured or arranged in a certain physical manner. In various example embodiments, one or more computer systems (e.g., a standalone computer system, a client computer system, or a server computer system) or one or more hardware modules of a computer system (e.g., a processor or a group of processors) can be configured by software (e.g., an application or application portion) as a hardware module that operates to perform certain operations as described herein.

In some embodiments, a hardware module can be implemented mechanically, electronically, or any suitable combination thereof. For example, a hardware module can include dedicated circuitry or logic that is permanently configured to perform certain operations. For example, a hardware module can be a special-purpose processor, such as a Field-Programmable Gate Array (FPGA) or an Application Specific Integrated Circuit (ASIC). A hardware module may also include programmable logic or circuitry that is temporarily configured by software to perform certain operations. For example, a hardware module can include software executed by a general-purpose processor or other programmable processor. Once configured by such software, hardware modules become specific machines (or specific components of a machine) uniquely tailored to perform the configured functions and are no longer general-purpose processors. It will be appreciated that the decision to implement a hardware module mechanically, in dedicated and permanently configured circuitry, or in temporarily configured circuitry (e.g., configured by software) can be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software accordingly configures a particular processor or processors, for example, to constitute a particular hardware module at one instance of time and to constitute a different hardware module at a different instance of time.

Hardware modules can provide information to, and receive information from, other hardware modules. Accordingly, the described hardware modules can be regarded as being communicatively coupled. Where multiple hardware modules exist contemporaneously, communications can be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module can perform an operation and store the output of that operation in a memory device to which it is communicatively coupled. A further hardware module can then, at a later time, access the memory device to retrieve and process the stored output. Hardware modules can also initiate communications with input or output devices, and can operate on a resource (e.g., a collection of information).

The various operations of example methods described herein can be performed, at least partially, by one or more processors that are temporarily configured (e.g., by software) or permanently configured to perform the relevant operations. Whether temporarily or permanently configured, such processors constitute processor-implemented modules that operate to perform one or more operations or functions described herein. As used herein, “processor-implemented module” refers to a hardware module implemented using one or more processors.

Similarly, the methods described herein can be at least partially processor-implemented, with a particular processor or processors being an example of hardware. For example, at least some of the operations of a method can be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some example embodiments, the processors or processor-implemented modules can be located in a single geographic location (e.g., within a home environment, an office environment, or a server farm). In other example embodiments, the processors or processor-implemented modules are distributed across a number of geographic locations.

The modules, methods, applications and so forth described in conjunction with FIGS. 1-9 are implemented in some embodiments in the context of a machine and an associated software architecture. The sections below describe representative software architecture and machine (e.g., hardware) architecture that are suitable for use with the disclosed embodiments.

Software architectures are used in conjunction with hardware architectures to create devices and machines tailored to particular purposes. For example, a particular hardware architecture coupled with a particular software architecture will create a mobile device, such as a mobile phone, tablet device, and the like. While yet another combination produces a server computer for use within a cloud computing architecture. Not all combinations of such software and hardware architectures are presented here as those of skill in the art can readily understand how to implement the inventive subject matter in different contexts from the disclosure contained herein.

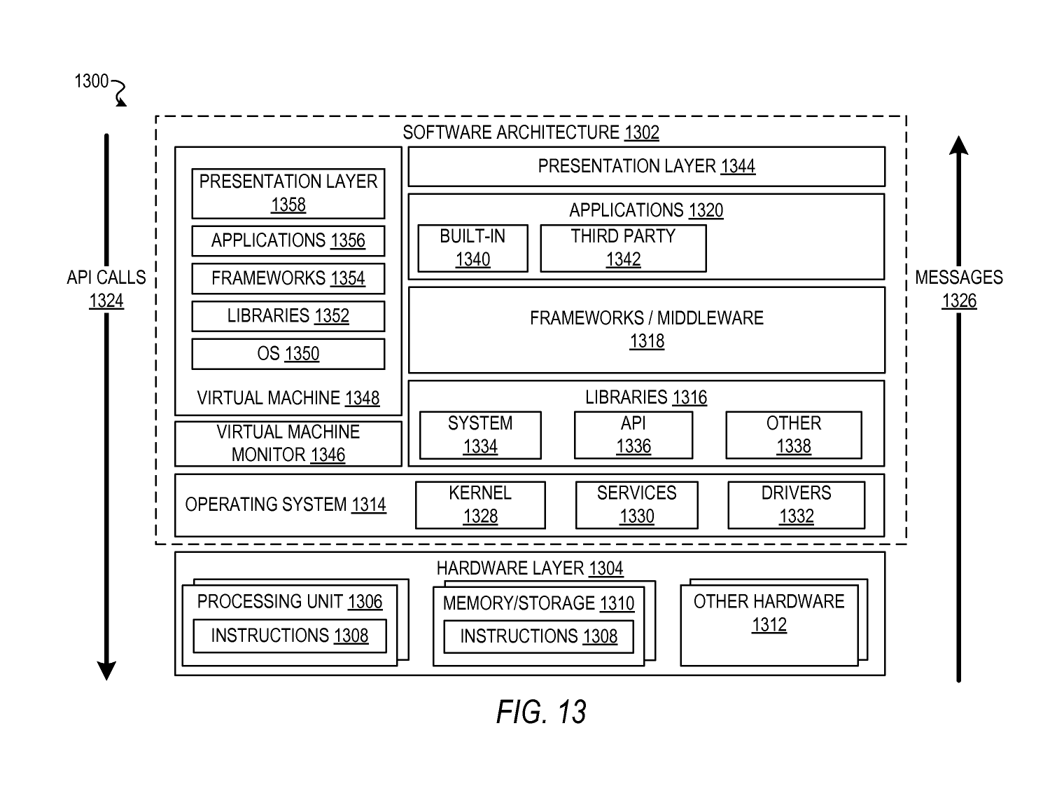

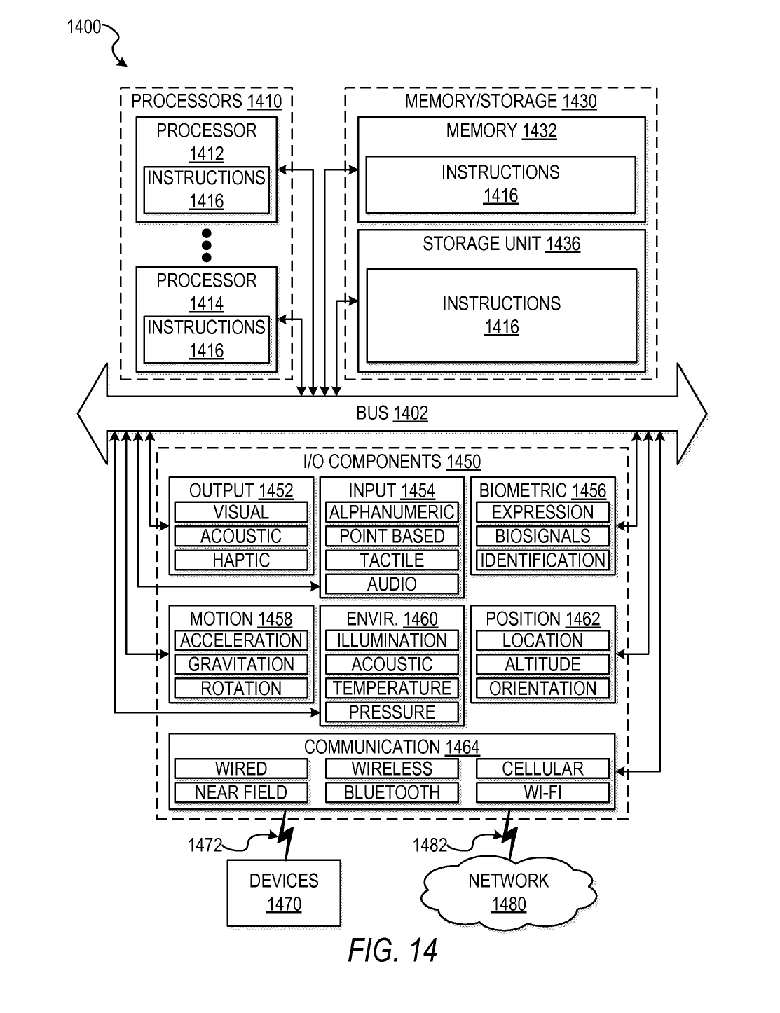

FIG. 13 is a block diagram 1300 illustrating a representative software architecture 1302, which may be used in conjunction with various hardware architectures herein described. FIG. 13 is merely a non-limiting example of a software architecture and it will be appreciated that many other architectures may be implemented to facilitate the functionality described herein. The software architecture 1302 may be executing on hardware such as machine 1400 of FIG. 14 that includes, among other things, processors 1410, memory/storage 1430, and I/O components 1450. A representative hardware layer 1304 is illustrated and can represent, for example, the machine 1400 of FIG. 14. The representative hardware layer 1304 comprises one or more processing units 1306 having associated executable instructions 1308. Executable instructions 1308 represent the executable instructions of the software architecture 1302, including implementation of the methods, modules and so forth of FIGS. 1-9. Hardware layer 1304 also includes memory and storage modules 1310, which also have executable instructions 1308. Hardware layer 1304 may also comprise other hardware 1312, which represents any other hardware of the hardware layer 1304, such as the other hardware illustrated as part of machine 1400.

In the example architecture of FIG. 13, the software architecture 1302 may be conceptualized as a stack of layers where each layer provides particular functionality. For example, the software architecture 1302 may include layers such as an operating system 1314, libraries 1316, frameworks/middleware 1318, applications 1320 and presentation layer 1344. Operationally, the applications 1320 or other components within the layers may invoke application programming interface (API) calls 1324 through the software stack and receive a response, returned values, and so forth illustrated as messages 1326 in response to the API calls 1324. The layers illustrated are representative in nature and not all software architectures have all layers. For example, some mobile or special purpose operating systems may not provide the frameworks/middleware 1318, while others may provide such a layer. Other software architectures may include additional or different layers.

The operating system 1314 may manage hardware resources and provide common services. The operating system 1314 may include, for example, a kernel 1328, services 1330, and drivers 1332. The kernel 1328 may act as an abstraction layer between the hardware and the other software layers. For example, the kernel 1328 may be responsible for memory management, processor management (e.g., scheduling), component management, networking, security settings, and so on. The services 1330 may provide other common services for the other software layers. The drivers 1332 may be responsible for controlling or interfacing with the underlying hardware. For instance, the drivers 1332 may include display drivers, camera drivers, BLUETOOTH® drivers, flash memory drivers, serial communication drivers (e.g., Universal Serial Bus (USB) drivers), WI-FI® drivers, audio drivers, power management drivers, and so forth depending on the hardware configuration.

The libraries 1316 may provide a common infrastructure that may be utilized by the applications 1320 or other components or layers. The libraries 1316 typically provide functionality that allows other software modules to perform tasks in an easier fashion than to interface directly with the underlying operating system 1314 functionality (e.g., kernel 1328, services 1330 or drivers 1332). The libraries 1316 may include system libraries 1334 (e.g., C standard library) that may provide functions such as memory allocation functions, string manipulation functions, mathematic functions, and the like. In addition, the libraries 1316 may include API libraries 1336 such as media libraries (e.g., libraries to support presentation and manipulation of various media format such as MPREG4, H.264, MP3, AAC, AMR, JPG, or PNG), graphics libraries (e.g., an OpenGL framework that may be used to render 2D and 3D in a graphic content on a display), database libraries (e.g., SQLite that may provide various relational database functions), web libraries (e.g., WebKit that may provide web browsing functionality), and the like. The libraries 1316 may also include a wide variety of other libraries 1338 to provide many other APIs to the applications 1320 and other software components/modules.

The frameworks/middleware 1318 (also sometimes referred to as middleware) may provide a higher-level common infrastructure that may be utilized by the applications 1320 or other software components/modules. For example, the frameworks/middleware 1318 may provide various graphic user interface (GUI) functions, high-level resource management, high-level location services, and so forth. The frameworks/middleware 1318 may provide a broad spectrum of other APIs that may be utilized by the applications 1320 or other software components/modules, some of which may be specific to a particular operating system or platform.

The applications 1320 include built-in applications 1340 or third party applications 1342. Examples of representative built-in applications 1340 may include, but are not limited to, a contacts application, a browser application, a book reader application, a location application, a media application, a messaging application, or a game application. Third party applications 1342 may include any of the built-in applications as well as a broad assortment of other applications. In a specific example, the third party application 1342 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or other mobile operating systems. In this example, the third party application 1342 may invoke the API calls 1324 provided by the mobile operating system such as operating system 1314 to facilitate functionality described herein.

The applications 1320 may utilize built-in operating system functions (e.g., kernel 1328, services 1330 or drivers 1332), libraries (e.g., system libraries 1334, API libraries 1336, and other libraries 1338), frameworks/middleware 1318 to create user interfaces to interact with users of the system. Alternatively, or additionally, in some systems interactions with a user may occur through a presentation layer, such as presentation layer 1344. In these systems, the application/module “logic” can be separated from the aspects of the application/module that interact with a user.

Some software architectures utilize virtual machines. In the example of FIG. 13, this is illustrated by virtual machine 1348. A virtual machine creates a software environment where applications/modules can execute as if they were executing on a hardware machine (such as the machine 1400 of FIG. 14, for example). The virtual machine 1348 is hosted by a host operating system (operating system 1314 in FIG. 14) and typically, although not always, has a virtual machine monitor 1346, which manages the operation of the virtual machine 1348 as well as the interface with the host operating system (i.e., operating system 1314). A software architecture executes within the virtual machine 1348 such as an operating system 1350, libraries 1352, frameworks/middleware 1354, applications 1356 or presentation layer 1358. These layers of software architecture executing within the virtual machine 1348 can be the same as corresponding layers previously described or may be different.

FIG. 14 is a block diagram illustrating components of a machine 1400, according to some example embodiments, able to read instructions from a machine-readable medium (e.g., a machine-readable storage medium) and perform any one or more of the methodologies discussed herein. Specifically, FIG. 14 shows a diagrammatic representation of the machine 1400 in the example form of a computer system, within which instructions 1416 (e.g., software, a program, an application, an applet, an app, or other executable code) for causing the machine 1400 to perform any one or more of the methodologies discussed herein can be executed. For example, the instructions 1416 can cause the machine 1400 to execute the flow diagrams of FIGS. 4-9. Additionally, or alternatively, the instruction 1416 can implement the presentation module 210, the communication module 220, the data module 230, the extraction module 240, the filter module 250, and the trend module 260 of FIG. 2, and so forth. The instructions 1416 transform the general, non-programmed machine into a particular machine programmed to carry out the described and illustrated functions in the manner described. In alternative embodiments, the machine 1400 operates as a standalone device or can be coupled (e.g., networked) to other machines. In a networked deployment, the machine 1400 may operate in the capacity of a server machine or a client machine in a server-client network environment, or as a peer machine in a peer-to-peer (or distributed) network environment. The machine 1400 can comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1416, sequentially or otherwise, that specify actions to be taken by the machine 1400. Further, while only a single machine 1400 is illustrated, the term “machine” shall also be taken to include a collection of machines 1400 that individually or jointly execute the instructions 1416 to perform any one or more of the methodologies discussed herein.

The machine 1400 can include processors 1410, memory/storage 1430, and I/O components 1450, which can be configured to communicate with each other such as via a bus 1402. In an example embodiment, the processors 1410 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) can include, for example, processor 1412 and processor 1414 that may execute instructions 1416. The term “processor” is intended to include multi-core processor that may comprise two or more independent processors (sometimes referred to as “cores”) that can execute instructions contemporaneously. Although FIG. 14 shows multiple processors 1410, the machine 1400 may include a single processor with a single core, a single processor with multiple cores (e.g., a multi-core processor), multiple processors with a single core, multiple processors with multiples cores, or any combination thereof.

The memory/storage 1430 can include a memory 1432, such as a main memory, or other memory storage, and a storage unit 1436, both accessible to the processors 1410 such as via the bus 1402. The storage unit 1436 and memory 1432 store the instructions 1416 embodying any one or more of the methodologies or functions described herein. The instructions 1416 can also reside, completely or partially, within the memory 1432, within the storage unit 1436, within at least one of the processors 1410 (e.g., within the processor's cache memory), or any suitable combination thereof, during execution thereof by the machine 1400. Accordingly, the memory 1432, the storage unit 1436, and the memory of the processors 1410 are examples of machine-readable media.

As used herein, the term “machine-readable medium” means a device able to store instructions and data temporarily or permanently and may include, but is not be limited to, random-access memory (RAM), read-only memory (ROM), buffer memory, flash memory, optical media, magnetic media, cache memory, other types of storage (e.g., Erasable Programmable Read-Only Memory (EEPROM)) or any suitable combination thereof. The term “machine-readable medium” should be taken to include a single medium or multiple media (e.g., a centralized or distributed database, or associated caches and servers) able to store instructions 1416. The term “machine-readable medium” shall also be taken to include any medium, or combination of multiple media, that is capable of storing instructions (e.g., instructions 1416) for execution by a machine (e.g., machine 1400), such that the instructions, when executed by one or more processors of the machine 1400 (e.g., processors 1410), cause the machine 1400 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 1450 can include a wide variety of components to receive input, provide output, produce output, transmit information, exchange information, capture measurements, and so on. The specific I/O components 1450 that are included in a particular machine will depend on the type of machine. For example, portable machines such as mobile phones will likely include a touch input device or other such input mechanisms, while a headless server machine will likely not include such a touch input device. It will be appreciated that the I/O components 1450 can include many other components that are not shown in FIG. 14. The I/O components 1450 are grouped according to functionality merely for simplifying the following discussion, and the grouping is in no way limiting. In various example embodiments, the I/O components 1450 can include output components 1452 and input components 1454. The output components 1452 can include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1454 can include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instruments), tactile input components (e.g., a physical button, a touch screen that provides location and force of touches or touch gestures, or other tactile input components), audio input components (e.g., a microphone), and the like.

In further example embodiments, the I/O components 1450 can include biometric components 1456, motion components 1458, environmental components 1460, or position components 1462 among a wide array of other components. For example, the biometric components 1456 can include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 1458 can include acceleration sensor components (e.g., an accelerometer), gravitation sensor components, rotation sensor components (e.g., a gyroscope), and so forth. The environmental components 1460 can include, for example, illumination sensor components (e.g., a photometer), temperature sensor components (e.g., one or more thermometers that detect ambient temperature), humidity sensor components, pressure sensor components (e.g., a barometer), acoustic sensor components (e.g., one or more microphones that detect background noise), proximity sensor components (e.g., infrared sensors that detect nearby objects), gas sensor components (e.g., machine olfaction detection sensors, gas detection sensors to detect concentrations of hazardous gases for safety or to measure pollutants in the atmosphere), or other components that may provide indications, measurements, or signals corresponding to a surrounding physical environment. The position components 1462 can include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication can be implemented using a wide variety of technologies. The I/O components 1450 may include communication components 1464 operable to couple the machine 1400 to a network 1480 or devices 1470 via a coupling 1482 and a coupling 1472, respectively. For example, the communication components 1464 include a network interface component or other suitable device to interface with the network 1480. In further examples, communication components 1464 include wired communication components, wireless communication components, cellular communication components, Near Field Communication (NFC) components, BLUETOOTH® components (e.g., BLUETOOTH® Low Energy), WI-FI® components, and other communication components to provide communication via other modalities. The devices 1470 may be another machine or any of a wide variety of peripheral devices (e.g., a peripheral device coupled via a Universal Serial Bus (USB)).

Moreover, the communication components 1464 can detect identifiers or include components operable to detect identifiers. For example, the communication components 1464 can include Radio Frequency Identification (RFID) tag reader components, NFC smart tag detection components, optical reader components (e.g., an optical sensor to detect one-dimensional bar codes such as a Universal Product Code (UPC) bar code, multi-dimensional bar codes such as a Quick Response (QR) code, Aztec Code, Data Matrix, Dataglyph, MaxiCode, PDF417, Ultra Code, Uniform Commercial Code Reduced Space Symbology (UCC RSS)-2D bar codes, and other optical codes), acoustic detection components (e.g., microphones to identify tagged audio signals), or any suitable combination thereof. In addition, a variety of information can be derived via the communication components 1464, such as location via Internet Protocol (IP) geo-location, location via WI-FI® signal triangulation, location via detecting a BLUETOOTH® or NFC beacon signal that may indicate a particular location, and so forth.

In various example embodiments, one or more portions of the network 1480 can be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a WI-FI® network, another type of network, or a combination of two or more such networks. For example, the network 1480 or a portion of the network 1480 may include a wireless or cellular network, and the coupling 1482 may be a Code Division Multiple Access (CDMA) connection, a Global System for Mobile communications (GSM) connection, or other type of cellular or wireless coupling. In this example, the coupling 1482 can implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

The instructions 1416 can be transmitted or received over the network 1480 using a transmission medium via a network interface device (e.g., a network interface component included in the communication components 1464) and utilizing any one of a number of well-known transfer protocols (e.g., Hypertext Transfer Protocol (HTTP)). Similarly, the instructions 1416 can be transmitted or received using a transmission medium via the coupling 1472 (e.g., a peer-to-peer coupling) to devices 1470. The term “transmission medium” shall be taken to include any intangible medium that is capable of storing, encoding, or carrying the instructions 1416 for execution by the machine 1400, and includes digital or analog communications signals or other intangible medium to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A system comprising:
a data module to access, from a couple data store, trade data corresponding to a plurality of transactions;
an extraction module to extract transaction attributes from the trade data, the transaction attributes including a cross-border relationship attribute indicating that a particular transaction is associated with a border transgression;
a filter module to filter the plurality of transactions according to the cross-border relationship attribute;
a trend module, implemented by at least one hardware processor of a machine, to infer a trend based on the extracted transaction attributes of the filtered plurality of transactions; and
a presentation module to:
generate a visualization representative of the filtered plurality of transactions using the extracted transaction attributes for the filtered plurality of transactions and the trend, and
cause display of the visualization on a user interface of a user device of a user.

2. The system of claim 1:
wherein the trend module is further to generate a trend alert message describing the trend in response to inferring the trend;
the system further comprising a communication module to automatically transmit the trend alert message to the user device of the user.

3. The system of claim 1:
wherein the presentation module is further to cause display of a user interface configured to receive a user-specification of a filter from the user device of the user, the user-specification of the filter including instructions for filtering the plurality of transactions according to user-specified transaction attributes;
the system further comprising a communication module to receive a user-specification of a filter from the user device of the user;
wherein the filtering the plurality of transactions is filtered according to the user-specification of the filter.

4. The system of claim 1:
wherein the data module is further to:
access user data for a plurality of users, the user data indicating user transaction activity,
identify a particular user among the plurality of users based on the user data and the cross-border relationship attribute, and
generate a link to a visualization configuration for the visualization representative of the filtered plurality of transactions filtered according to the user-specification of the filter;
the system further comprising a communication module to transmit the generated link to a user device of the particular user.

5. A method comprising:
accessing trade data corresponding to a plurality of transactions;
extracting transaction attributes from the trade data, the transaction attributes including a cross-border relationship attribute indicating that a particular transaction is associated with a border transgression;
filtering the plurality of transactions according to the cross-border relationship attribute;
inferring a trend based on the extracted transaction attributes of the filtered plurality of transactions;
generating a visualization representative of the filtered plurality of transactions using the extracted transaction attributes for the filtered plurality of transactions and the trend; and
causing display of the visualization on a user interface of a user device of a user.

6. The method of claim 5, further comprising:
generating a trend alert message describing the trend in response to inferring the trend; and
automatically transmitting the trend alert message to the user device of the user.

7. The method of claim 5, further comprising:
causing display of a user interface configured to receive a user-specification of a filter from the user device of the user, the user-specification of the filter including instructions for filtering the plurality of transactions according to a user-specified transaction attribute; and
receiving a user-specification of a filter from the user device of the user,
wherein the filtering the plurality of transactions is filtered according to the user-specification of the filter.

8. The method of claim 5, further comprising:
accessing user data for a plurality of users, the user data indicating user transaction activity;
identifying a particular user among the plurality of users based on the user data and the cross-border relationship attribute;
generating a link to a visualization configuration for the visualization representative of the filtered plurality of transactions filtered according to the user-specification of the filter; and
transmitting the generated link to a user device of the particular user.

9. The method of claim 5, further comprising:
automatically performing a task on behalf of the user in response to inferring the trend, wherein the task comprises automatically listing for sale a portion of an inventory of the user associated with the trend.

10. The method of claim 5, wherein the trade data includes data for historical transactions and data for real-time transactions.

11. The method of claim 5, wherein the visualization shows bi-directional trade between a first country and a second country.

12. The method of claim 5, wherein the visualization comprises a chord diagram comprising chord lines that represent transactions between countries.

13. A machine-readable medium having no transitory signals and storing instructions that, when executed by at least one processor of a machine, cause the machine to perform operations comprising:
accessing trade data corresponding to a plurality of transactions;
extracting transaction attributes from the trade data, the transaction attributes including a cross-border relationship attribute indicating that a particular transaction is associated with a border transgression;
filtering the plurality of transactions according to the cross-border relationship attribute;
inferring a trend based on the extracted transaction attributes of the filtered plurality of transactions;
generating a visualization representative of the filtered plurality of transactions using the extracted transaction attributes for the filtered plurality of transactions and the trend; and
causing display of the visualization on a user interface of a user device of a user.

14. The machine-readable medium of claim 13, wherein the operations further comprise:
generating a trend alert message describing the trend in response to inferring the trend; and
automatically transmitting a trend alert message to the user device of the user.

15. The machine-readable medium of claim 13, wherein the operations further comprise:
causing display of a user interface configured to receive a user-specification of a filter from the user device of the user, the user-specification of the filter including instructions for filtering the plurality of transactions according to user-specified transaction attributes; and
receiving a user-specification of a filter from the user device of the user,
wherein the filtering the plurality of transactions is filtered according to the user-specification of the filter.

16. The machine-readable medium of claim 13, wherein the operations further comprise:
accessing user data for a plurality of users, the user data indicating user transaction activity;
identifying a particular user among the plurality of users based on the user data and the cross-border relationship attribute;
generating a link to a visualization configuration for the visualization representative of the filtered plurality of transactions filtered according to the user-specification of the filter; and
transmitting the generated link to a user device of the particular user.

17. The machine-readable medium of claim 13, wherein the operations further comprise:
automatically performing a task on behalf of the user in response to inferring the trend, wherein the task comprises automatically listing for sale a portion of an inventory of the user associated with the trend.

18. The machine-readable medium of claim 13, wherein the trade data includes data for historical transactions and data for real-time transactions.

19. The machine-readable medium of claim 13, wherein the visualization shows bi-directional trade between a first country and a second country.

20. The machine-readable medium of claim 13, wherein the visualization comprises a chord diagram comprising chord lines that represent transactions between countries.
